(19) United States
(12) Patent Application Publication
(10) Pub. No.: US 2007/0118821 A1
(43) Pub. Date: May 24, 2007

(54) Displaying consumer device graphics using scalable vector graphics

(75) Inventors: Alan R. Yee, Millbrae, CA (US); Timothy M. Dunn, Vallecito, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/282,346

(22) Filed: Nov. 18, 2005

(51) Int. Cl. G09G 5/00; G06F 17/00

(52) U.S. Cl. 715/864; 345/660

(57) ABSTRACT

A system includes a Scalable Vector Graphics (SVG) image for representing at least one portion of a consumer electronic device and a scaler for scaling the SVG image to obtain a scaled SVG image where a display size of the scaled SVG image equals a predefined physical size of the at least one portion of the consumer electronic device where the SVG image is defined by an SVG tag.

### BACKGROUND

Many modern consumer electronic devices, such as mobile telephones, MP3 players, compact disc (CD) players, or personal digital assistants (PDAs), have small screens for displaying text and/or images. The screens may be in color or in grayscale. These screens, in actuality, are collections of tiny color or grayscale dots, called “pixels.”

A pixel is a single point on a digital screen or in a digital image. One may imagine a pixel as a tiny square. Because the square is so small, it appears as a dot or a point to the naked eye. A digital screen or image contains thousands or even millions of pixels, arranged in rows and columns. The pixels are so small and so close together that they appear connected. Collectively, these pixels form an image. A pixel, then, is the base unit of the digital screen or image. Therefore, conceptually, a pixel square always has a unit size that equals a width of one unit and a height of one unit.

The total number of pixels displayed on a digital screen or within an image is considered to be the resolution of that screen or image. For example, if an image has 100 pixels per row and 100 rows in total, then the resolution of this image is 100 pixels by 100 pixels, or 10,000 pixels. The higher the resolution, that is, the greater the number of pixels, an image has, the more graphical information the image contains.

Digital screens are devices that display digital images. The pixels that form the digital screens have an actual physical size. This physical size is different from and independent of the concept of “unit size” described above, where pixels are regarded as the base unit of the screens. Pixels found in different types of screens often have different physical sizes. Physically speaking, large screens usually have relatively large physical pixels, and small screens usually have relatively small physical pixels.

In general, screens on modern consumer electronic devices are many times smaller than computer or digital television screens. In order to maintain a particular resolution, the physical size of the pixels used to form the consumer electronic device screens are necessarily smaller than the physical size of the pixels used to form computer or digital television screens. However, in certain situations, consumer device images need to be displayed on a screen associated with a traditional computer system (e.g., a laptop, workstation, remote terminal system, etc.) instead. In addition, displaying images that represent the entire consumer electronic device itself (in the form of an emulator, simulator, etc.) on a computer screen is sometimes necessary.

For example, when designing a new consumer electronic device or modifying an existing model of a consumer electronic device to produce the next generation of the device, designers often visualize new designs through emulation to observe the new design prototypes prior to manufacturing. The emulation may also include visualizing various images likely to be displayed on the consumer electronic device screen. The visualization also helps the designers analyze each design and determine which design is better than the others from an aesthetic and/or functional standpoint. However, because the new designs have not been finalized, prototyped, or manufactured, it is often less expensive and more convenient to model the new designs using a computer system and display images representing the new designs on the computer screen.

For visualization purposes, designers often need to display the images that represent the new designs of the consumer electronic device on computer screens in the same physical size as the actual physical size of the corresponding device. This allows the designers to have a more accurate “look and feel” of what their designs would be like in the real world. Because most computer screens have pixels that are physically larger than the pixels of the consumer electronic device screens, it is often necessary to scale the images that represent the new designs down, so that when displayed on the computer screens, these images maintain a display size that equals the actual physical size of the corresponding consumer electronic device.

To illustrate, assume the physical size of the individual pixels on a consumer electronic device screen is 1/100 inches by 1/100 inches. An image, whose resolution is 100 pixels by 100 pixels, is meant to be displayed on the consumer electronic device screen. Thus, when this image is displayed on the consumer electronic device screen, its display size, that is, the physical size of the actually displayed image is 1 inch by 1 inch.

In addition, assume the physical size of the individual pixels on a designer's computer screen is 1/50 inches by 1/50 inches. When the designer views the same 100 pixels by 100 pixels image on his own computer screen, the display size of the image is 2 inches by 2 inches. Because the pixels on the computer screen is four times larger than the pixels on the consumer electronic device screen, in order to view the image on the computer screen in the same display size as would be seen on the consumer electronic device screen, the image needs to be scaled down to one-fourth of its original resolution, that is, to 50 pixels by 50 pixels, before it is displayed on the designer's computer screen.

Raster images are those images formed by collections of pixels. When scaling raster images, various algorithms may be used, including nearest neighbor, bilinear, or bicubic interpolation. Because of the nature of raster images, some lossiness occurs during the scaling of raster images. That is, a certain amount of details are lost or blurred after a raster image is scaled, either because a certain amount of pixels are lost when the image is scaled down in resolution or because not enough information exists in the original image when the image is scaled up in resolution. In the above example, when the image is scaled down to one-fourth of its original resolution, three-fourths of the pixels in the original image are lost. Such lossiness is especially prevalent when working with raster images of small resolutions.

### SUMMARY

In general, in one aspect, the invention relates to a system comprising a Scalable Vector Graphics (SVG) image for representing at least one portion of a consumer electronic device, and a scaler for scaling the SVG image to obtain a scaled SVG image, wherein a display size of the scaled SVG image equals a predefined physical size of the at least one portion of the consumer electronic device, wherein the SVG image is defined by an SVG tag.

In general, in one aspect, the invention relates to a method comprising representing at least one portion of a consumer electronic device using a Scalable Vector Graphics (SVG) image, wherein the SVG image is defined by an SVG tag, and scaling the SVG image to obtain a scaled SVG image, wherein a display size of the scaled SVG image equals a predefined physical size of the at least one portion of the consumer electronic device

In general, in one aspect, the invention relates to a computer readable medium comprising software instructions for enabling a computer system under the control of a processor to represent at least one portion of a consumer electronic device using a Scalable Vector Graphics (SVG) image, wherein the SVG image is defined by an SVG tag, and scale the SVG image to obtain a scaled SVG image, wherein a display size of the scaled SVG image equals a predefined physical size of the at least one portion of the consumer electronic device.

Other aspects of the invention will be apparent from the following description and the appended claims.

### BRIEF DESCRIPTION OF THE DRAWINGS

FIG. 1 shows a flow diagram of a system in accordance with one or more embodiments of the invention.

FIG. 2 shows a flow diagram of a system in accordance with one or more embodiments of the invention.

FIG. 3 shows a flowchart of a method in accordance with one or more embodiments of the invention.

FIG. 4 shows a comparison between an original unscaled image representing a consumer electronic device and a scaled SVG image representing the same consumer electronic device in accordance with one or more embodiments of the invention.

FIG. 5 shows a comparison between an original unscaled image representing a consumer electronic device and a scaled raster image representing the same consumer electronic device in accordance with one or more embodiments of the invention.

FIG. 6 shows a computer system in accordance with one or more embodiments of the invention.

### DETAILED DESCRIPTION

Exemplary embodiments of the invention will be described with reference to the accompanying figures. Like elements in the figures are denoted by like reference numerals for consistency.

In the exemplary embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily confusing the description.

SVG, or Scalable Vector Graphics, is a language for describing two-dimensional graphics in Extensible Markup Language (XML). In one or more embodiments of the invention, this description conforms to the standard specification for SVG from the World Wide Web Consortium (W3C). In addition, the SVG Mobile Profiles, which includes SVG Basic and SVG Tiny, specifically target the resource-limited devices, such as mobile telephones.

Two-dimensional graphical objects, such as lines, rectangles, circles, etc., may be defined using a specific language structure, called a “tag.” SVG tags conform to the syntax of XML tags. Each tag defines a particular type of graphical object. For example, a line in the two-dimensional space may be defined by a starting point (x1, y1) and an ending point (x2, y2), where x1, y1, x2, and y2 represent the x- and y-coordinate of the starting and ending point of the line respectively. Thus, to define a line that starts at (100, 20) and ends at (200, 50), the SVG tag would be <LINE X1=“100” Y1=“20” X2=“200” Y2=“50”>. A circle in the two-dimensional space may be defined by an origin (x, y), where x and y represent the x- and y-coordinate of the origin point, and a radius. Thus, to define a circle that has an origin at (40, 10) and a radius of 20, the SVG tag would be <CIRCLE X=“40” Y=“10” RADIUS=“20”>.

An SVG image, in essence, is the data contained within the SVG tag, i.e., the coordinates for the line or the circle. Note that the term “image,” as used throughout this description, is generic. A line or a circle each by itself is an image, but a line and a circle together form another image. Accordingly, an SVG tag defines an SVG image and two or more SVG tags collectively also define an SVG image.

In addition, SVG images are vector images. Vector images are images defined using the characteristics of the graphical objects, including but not limited to the shape, coordinates, size, and color of the objects. For example, an image of a rectangle in vector format may be defined by the coordinates of the rectangle's upper-left and lower-right corner. Recall that in contrast, raster images are images formed by collections of pixels. Thus, an image of the same rectangle in raster format would be many rows and columns of pixels or dots forming the shape of the rectangle.

To display and view an SVG image defined using an SVG tag on a digital screen, the SVG tag is first processed to extract the data, i.e., the SVG image, contained inside the tag. In the example above, the coordinates for the starting and ending point of the line are extracted from the line tag, or the radius and the coordinates for the origin of the circle are extracted from the circle tag. These data are then processed, which may include scaling the line and the circle.

Digital display devices, such as computer screens or consumer electronic device screens, are collections of pixels. Therefore, these display devices are also referred to as raster display devices. To display an SVG image, which is a vector format image, on such a raster display device, the SVG image first needs to be rasterized, that is, converted into raster format. The process of converting a vector image into raster format is called “rendering.”

There are various algorithms for rendering a vector image into raster format known in the art. Essentially, for all algorithms, a collection of pixels of different colors and transparency levels are used to represent the graphical object(s) in the vector image. For example, a red line that starts at coordinate (0, 0) and ends at coordinate (1, 1) may be represented by a group of red pixels lined up one next to another forming a line in 45-degree angle. In other words, a collection of pixels is used to approximate the line. After the SVG image is rendered into raster format, its equivalent raster image can then be displayed on a digital screen.

When an image is displayed on a digital screen, regardless of what type of screen (e.g., computer screen, digital television screen, consumer electronic device screen, etc.), a certain number of pixels are needed to display that image. Because pixels on a screen are physical objects, the image displayed on the screen has a certain physical size, that is, a width and a height. The physical size of the image when displayed on a particular screen is the display size of the image on that screen. Because different screens may have pixels of different physical sizes, the display size of the image would differ when the same image is displayed on different screens. In other words, the display size of an image is display device specific.

The physical size of the pixels on the display devices may vary depending on factors such as the materials used to manufacture the pixels or the physical size and resolution of the display devices. For example, assume a screen has a resolution of 2,000 pixels by 1,500 pixels, that is, 2,000 pixels per row and 1,500 rows in total. If pixels of physical size 1/100 inches by 1/100 inches are used to form the screen, then the physical size of the screen would be 20 inches by 15 inches. On the other hand, if pixels of physical size 1/200 inches by 1/200 inches are used to form the same screen, then the physical size of the screen would be 10 inches by 7.5 inches.

Conversely, for example, assume a screen has a physical size of 20 inches by 15 inches. If pixels of physical size 1/100 inches by 1/100 inches are used to form the screen, then the resolution of the screen would be 2,000 by 1,500 pixels. On the other hand, if pixels of physical size 1/200 inches by 1/200 inches are used to form the same screen, then the resolution of the screen would be 4,000 by 3,000 pixels.

As the above two examples show, the physical size of the pixels used to form the screen, the physical size of the screen, and the resolution of the screen are interdependent of one another. Often, pixels of different physical sizes are used to form screens of different physical sizes and resolutions. If a screen has a large physical size and a moderate resolution, then pixels of relatively large physical size should be used to form that screen. Conversely, if a screen has a small physical size and a moderate to high resolution, then pixels of relatively small physical size should be used.

The display size of an image on a particular screen depends on the physical size of the pixels forming that screen. To illustrate, assume a first screen has a resolution of 2,000 pixels by 2,000 pixels and a physical size of 20 inches by 20 inches. This mean the physical size of the pixels of the first screen is 1/100 inches by 1/100 inches. If an image of 1,000 pixels by 1,000 pixels is displayed on this first screen, then the display size of the image would be 10 inches by 10 inches. On the other hand, assume a second screen has a resolution of 4,000 pixels by 4,000 pixels and a physical size also of 20 inches by 20 inches. This mean the physical size of the pixels of the second screen is 1/200 inches by 1/200 inches. If the same image of 1,000 pixels by 1,000 pixels is displayed on this second screen, then the display size of the image would be 5 inches by 5 inches.

In general, embodiments of the invention relate to an apparatus and a method for displaying an image that represents at least one portion of a consumer electronic device, where the display size of the image equals the actual physical size of the portion(s) of the consumer electronic device represented by the image. More specifically, embodiments of the invention relate to defining an SVG image that represents at least one portion of the consumer electronic device using an SVG tag. The SVG image is scaled based on the specific needs of the users. For example, the scaled SVG image, when rendered into raster format and displayed on a particular display device, would have a display size that equals the actual physical size of the portion(s) of the consumer electronic device represented by the SVG image. The scaled SVG image is then rendered into raster format and displayed on the display device, such as a computer screen.

One skilled in the art will appreciate that the SVG image may represent an image of the entire consumer electronic device or only a portion of the consumer electronic device. In one or more embodiments of the invention, the SVG image represents an image that is meant to be displayed on the screen of the consumer electronic device. The word “portion” as used in the instant application denotes at least one portion of the consumer electronic device, up to and including the entire viewable surface of the device as seen from any direction.

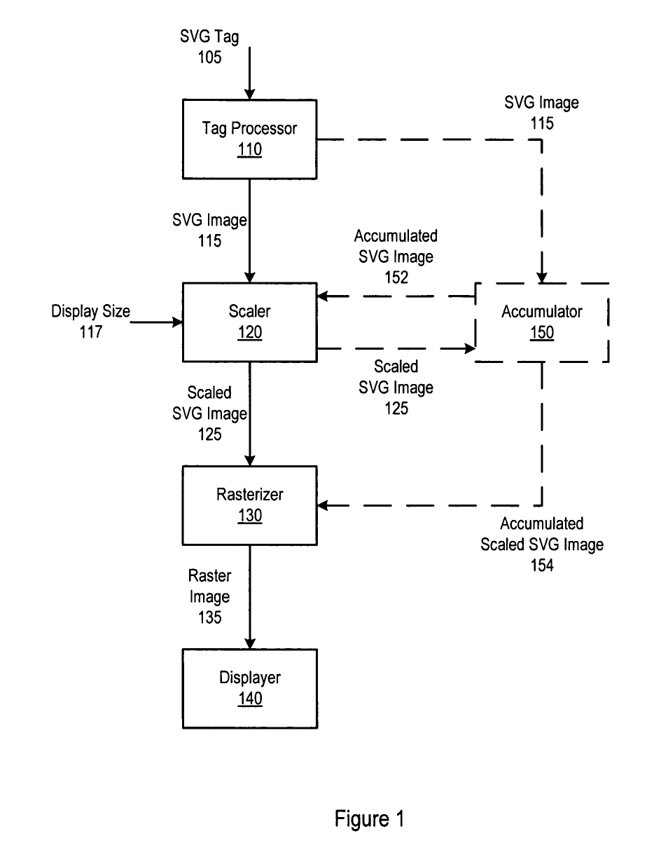

FIG. 1 illustrates a flow diagram of a system in accordance with one or more embodiments of the invention. In one or more embodiments of the invention, an SVG tag (105) is used to define an SVG image that represents a portion of a consumer electronic device. In one or more embodiments of the invention, multiple SVG tags define multiple SVG images that represent multiple portions of the consumer electronic device. These multiple SVG images, if combined, would form a new SVG image that represents a larger portion, which includes the individual smaller portions, of the consumer electronic device, again up to and including the entire viewable surface of the device as seen from any direction. However, one skilled in the art will appreciate that it is not necessary that when all the SVG images are combined, an image of the entire viewable surface of the consumer electronic device is formed.

A tag processor (110) processes the SVG tag (105) to extract the data contained within the SVG tag (105). As described above, these data define the actual SVG image (115) that represents the portion of the consumer electronic device. Thus, for the purpose of the instant invention, the data contained in the SVG tag (105) are conceptually equivalent to the SVG image (115) itself.

A scaler (120) scales the SVG image (115) to obtain a scaled SVG image (125), such that the scaled SVG image (125) has a particular display size when rendered and displayed on a particular display device. Recall that the same image has different display sizes when displayed on screens with pixels of different physical sizes.

In one embodiment of the invention, the scaled SVG image (125), when rendered and displayed on a particular display device, has a display size that equals the physical size of the portion of the consumer electronic device represented by the SVG image (115). The amount that the SVG image (115) needs to be scaled up or down is determined based on the physical size of the pixels on the display device, the original display size of the SVG image (115), and/or the physical size of the portion of the consumer electronic device represented by the SVG image (115).

To illustrate, assume the physical size of the pixels on a consumer electronic device screen is 1/100 inches by 1/100 inches, and the physical size of the pixels on a computer screen is 1/50 inches by 1/50 inches. An SVG image represents an image that is meant to be displayed on the consumer electronic device screen. Because the computer screen has pixels four times the size of the pixels on the consumer electronic device screen, in order for the image to have the same display size on the computer screen as it would be on the consumer electronic device screen, the image needs to be scaled down to one-fourth of its original size before it is displayed on the computer screen.

In one embodiment of the invention, the scaled SVG image (125) has a user-specified display size (117). The user-specified display size (117) is relayed to the scaler (120). The scaler (120) determines how much the SVG image (115) needs to be scaled up or down based on the user-specified display size (117), the original display size of the SVG image (115), and/or the physical size of the pixels of the display device where the image is to be displayed. For example, in addition to displaying an image of a portion of a consumer electronic device in a display size that equals the actual physical size of the corresponding portion of the consumer electronic device, the same image may be viewed in its original display size. It may also be desirable to view an enlarged version of the image so that it is easier to study the smaller details in the image.

To illustrate, assume an image originally has a display size of 2 inches by 2 inches when displayed on a particular screen, but the user-specified or user-desired display size (117) is 4 inches by 4 inches. Then, the image needs to be scaled up to four times its original size before it is displayed. That is, the display size of the scaled SVG image (125) should be four times the display size of the SVG image (115).

In one embodiment of the invention, a rasterizer (130) renders the scaled SVG image (125) into raster format to obtain a raster image (135). A displayer (140) displays the raster image (135) on a particular raster display device, such as a computer screen.

In one embodiment of the invention, the scaling and rendering of the SVG image (115) may be combined into one step. For example, assume an SVG image of a square is to be displayed on a computer screen. The coordinate of the lower-left corner of the square is (0, 0), the coordinate of the upper-left corner is (0, 1), the coordinate of the lower-right corner is (1, 0), and the coordinate of the upper-right corner is (1, 1). The square is blue and completely opaque. The physical size of the pixels on the computer screen is 1/100 inches by 1/100 inches. The desired display size for the square is 2 inches in width and 2 inches in height. If the SVG image (115) is rendered into raster format, such that the resulting raster image (135) has a resolution of 200 pixels by 200 pixels, that is, a total of 40,000 pixels arranged in a square of rows and columns, and all the pixels are blue and opaque, then when this raster image (135) is displayed on the computer screen, it would have a display size of 2 inches by 2 inches. In this case, one unit in vector format is equivalent to 200 pixels in raster format in both x- and y-direction.

In one embodiment of the invention, instead of scaling each SVG image (115) individually, an optional accumulator (150) accumulates all the SVG images (115) and combines them into a larger accumulated SVG image (152) that includes all the portions of the individual smaller SVG images (115). The accumulated SVG image (152) is then forwarded to the scaler (120) to be scaled.

In one embodiment of the invention, instead of rendering each scaled SVG image (125) individually, an optional accumulator (150) accumulates all the scaled SVG images (125) and combines them into a larger accumulated scaled SVG image (154) that includes all the portions of the individual smaller scaled SVG images (125). The accumulated scaled SVG image (154) is then forwarded to the rasterizer (130) to be rendered into raster format.

A system that displays the SVG images on a display device is called an SVG viewer or SVG engine. One skilled in the art will appreciate that many implementations of the SVG viewer or SVG engine exist. These SVG viewers typically support all the standard SVG tags defined in the W3C specification and can be used to display or view images defined using the standard SVG tags. In one or more embodiments of the invention, an existing SVG viewer is used to view the SVG images that represent the consumer electronic device.

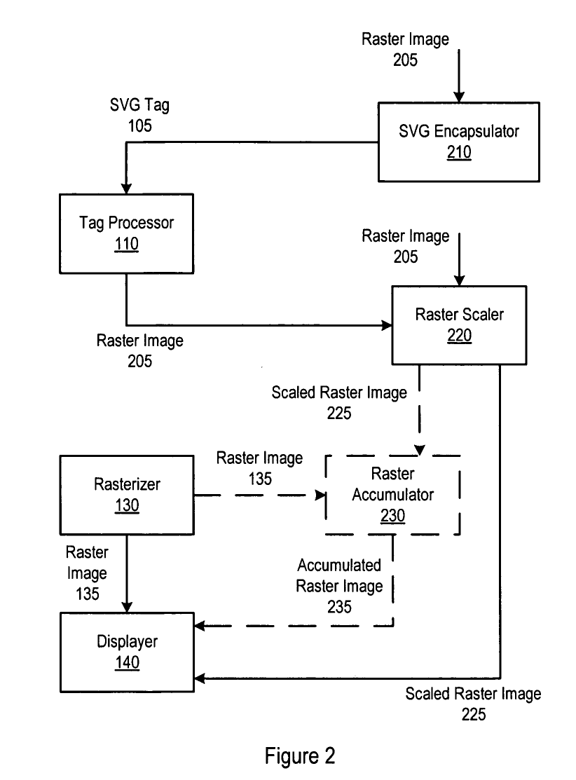

FIG. 2 illustrates an implementation of a system in accordance with one or more embodiments of the invention. In one or more embodiments of the invention, in addition to SVG images, the system also accepts images in raster format. In one embodiment of the invention, a raster image (205) that represents a portion of the consumer electronic device is sent to an SVG encapsulator (210). The SVG encapsulator (210) encapsulates the raster image (205) in an SVG tag (105), which is then forwarded to the tag processor (110).

In one or more embodiments of the invention, the SVG tag (105) that wraps around the raster image (205) should conform to the syntax of a standard SVG tag. For example, assume a Joint Photographic Experts Group (JPEG) image is saved in a file called “image.jpg.” JPEG is a specific type of raster image. A basic SVG tag (105) that wraps around this JPEG image would be <IMG SRC=“image.jpg”>.

The tag processor (110) processes the SVG tag (105) with the raster image (205) as it would process any other SVG tags and extracts the raster image (205) from the SVG tag (105). A raster scaler (220) scales the raster image (205) to a particular display size.

The reason to encapsulate the raster image (205) in an SVG tag (105) is to take advantage of the existing implementations of the SVG viewer, which often includes some form of the tag processor (110) and supports images in both SVG and raster format. However, it is not necessary that the raster image (205) be encapsulated in an SVG tag (105). In one embodiment of the invention, the raster image (205) is sent to the raster scaler (220) directly to be scaled to obtain a scaled raster image (225).

The operation of the raster scaler (220) is similar to the scaler (120) for the SVG images described above in FIG. 1. When scaling, the display size of the scaled raster image (225) equals the actual physical size of the portion of the consumer electronic device represented by the raster image (205) in accordance with one or more embodiments of the invention. The x and y scale factors, that is, how much the raster image (205) should be scaled up or down in the x- and y-direction respectively, are determined according to various factors, such as the resolution of the raster image (205), the actual physical size of the consumer electronic device, the physical size of the individual pixels on the intended display screen of the consumer electronic device, and/or the physical size of the individual pixels on the intended display screen.

For example, assume a raster image represents the keypad portion of a mobile telephone. The physical size of the telephone's keypad is 1 inch by 2 inches, and the resolution of the raster image is 200 pixels by 400 pixels. If the physical size of the individual pixels on the display screen is 1/50 inches by 1/50 inches, then in order to view the raster image in a display size that equals the actual physical size of the keypad, the image needs to be scaled down to a resolution of 50 pixels by 100 pixels, which is one-sixteenth of its original resolution. However, if the physical size of the individual pixels on the display screen is 1/200 inches by 1/200 inches, then the raster image already has a display size that equals the actual physical size of the keypad. In this case, no scaling is needed.

In one embodiment of the invention, an optional raster accumulator (230) accumulates all the scaled raster images (225) and the raster images (135) from the rasterizer (130), which are scaled SVG images rendered into raster format, and combines them into an accumulated raster image (235), which is a combined image of all the portions of the consumer electronic device individually defined by both the SVG and raster images. One skilled in the art will appreciate that the accumulated raster image (235) is not necessarily an image of the entire consumer electronic device, but may itself be a portion of the consumer electronic device. The displayer (140) then displays the accumulated raster image (235).

In one embodiment of the invention, scaled raster images (225) and raster images (135) from the rasterizer (130) are not accumulated but are displayed individually. In this case, the raster accumulator (230) is not used.

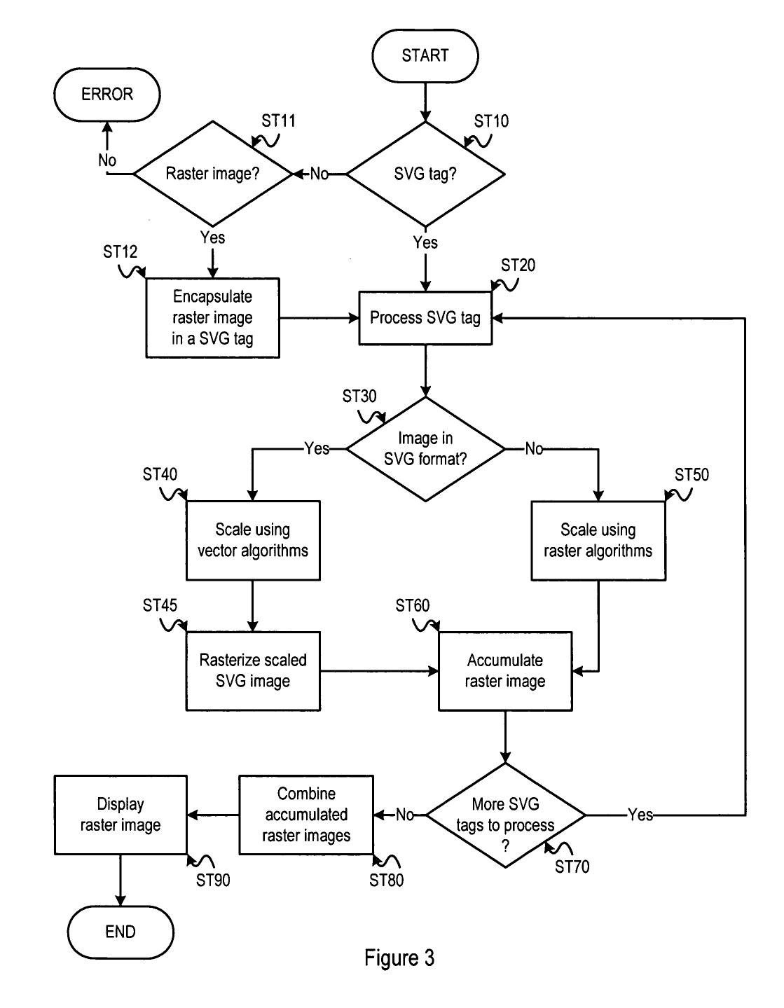

FIG. 3 shows a flowchart of a method in accordance with one or more embodiments of the invention. In one embodiment of the invention, the system accepts images of respective portions of a consumer electronic device both as SVG images and as raster images. If an image is defined in an SVG tag (ST10), the SVG tag is relayed directly to be processed. If the input is a raster image (ST11), the raster image is first encapsulated and wrapped inside an SVG tag (ST12) and then forwarded for processing. In one or more embodiments of the invention, all other formats of input result in error.

In one embodiment of the invention, each SVG tag is processed (ST20) to extract an image that represents a respective portion of the consumer electronic device. If the image within the SVG tag is a “real” SVG image (ST30), that is, not a raster image encapsulated in the SVG tag, then the SVG image is scaled using an appropriate vector algorithm (ST40) so that the display size of the scaled SVG image equals the actual physical size of the corresponding portion of the consumer electronic device or any other desirable sizes. The scaled SVG image is then rendered into raster format (ST45).

On the other hand, if the image within the SVG tag is really a raster image (ST30), which has been wrapped inside the SVG tag, then the raster image is scaled using an appropriate raster algorithm (ST50) so that the display size of the scaled raster image equals the actual physical size of the corresponding portion of the consumer electronic device or any other desirable sizes.

In one embodiment of the invention, each scaled image in raster format is accumulated (ST60). The process continues until all the SVG tags have been processed (ST70). The accumulated raster images are combined into a single raster image (ST80). The resulting combined raster image is then displayed (ST90). In one embodiment of the invention, no accumulation and combination of raster images are performed before being displayed. The process continues until all the SVG tags have been processed (ST70). The resulting rasterized images from the scaled SVG images and the scaled raster images are displayed individually (ST90).

In one or more embodiments of the invention, the system accepts SVG images that represent respective portions of the consumer electronic device only. In this embodiment of the invention, the SVG images are scaled (ST40), rendered into raster format (ST45), and displayed (ST90) individually, that is, one at a time. The SVG images may be first accumulated and combined into an accumulated SVG image, which may then be scaled, rendered into raster format, and displayed. Alternatively, in one or more embodiments of the invention, the SVG images are scaled individually. Next, the scaled SVG images are accumulated and combined into an accumulated scaled SVG image. The accumulated scaled SVG image is then rendered into raster format and displayed.

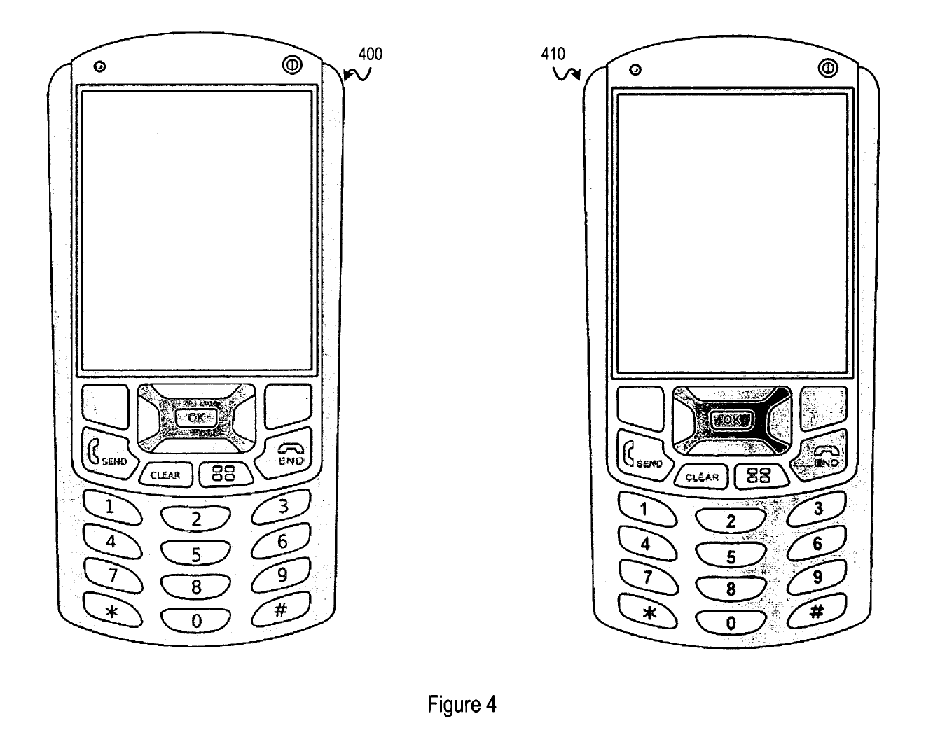

FIG. 4 shows a comparison between an original un-scaled image representing a consumer electronic device and a scaled SVG image representing the same consumer electronic device. The original image of the consumer electronic device, which has not been scaled, is shown on the left (400). The scaled SVG image is shown on the right (410). As shown, the scaling of the SVG image preserves maximum integrity of the graphical information in the original image of the consumer electronic device (400), and there is no visible lossiness after the SVG image has been scaled and rendered. All the details of original image of the consumer electronic device (400) are preserved in the scaled SVG image of the device (410).

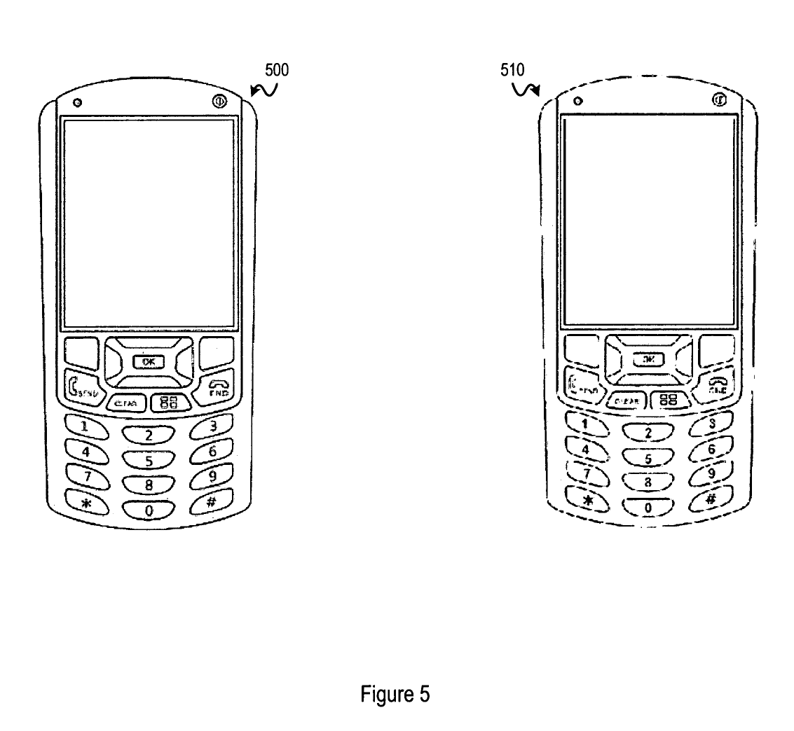

FIG. 5 shows a comparison between an original un-scaled image representing a consumer electronic device and a scaled raster image representing the same consumer electronic device. The original image of the consumer electronic device, which has not been scaled, is shown on the left (500). The scaled raster image is shown on the right (510). The scaling of the raster image experiences lossiness, that is, missing graphical details in the original image of the consumer electronic device (500). This is due to the nature of the scaling algorithm for raster images. For example, if an image were scaled down to half of its original resolution, then approximately half of the pixels in the original image would be lost after the scaling operation.

FIGS. 4 and 5 together illustrate the benefits of using SVG to define an image of a portion of a consumer electronic device over the raster format. By scaling the SVG image before rendering the SVG image into raster format for display, the resulting scaled image maximizes image integrity and minimizes lossiness so that the graphical details in the original SVG image of the portion of the consumer electronic device are preserved and displayed clearly.

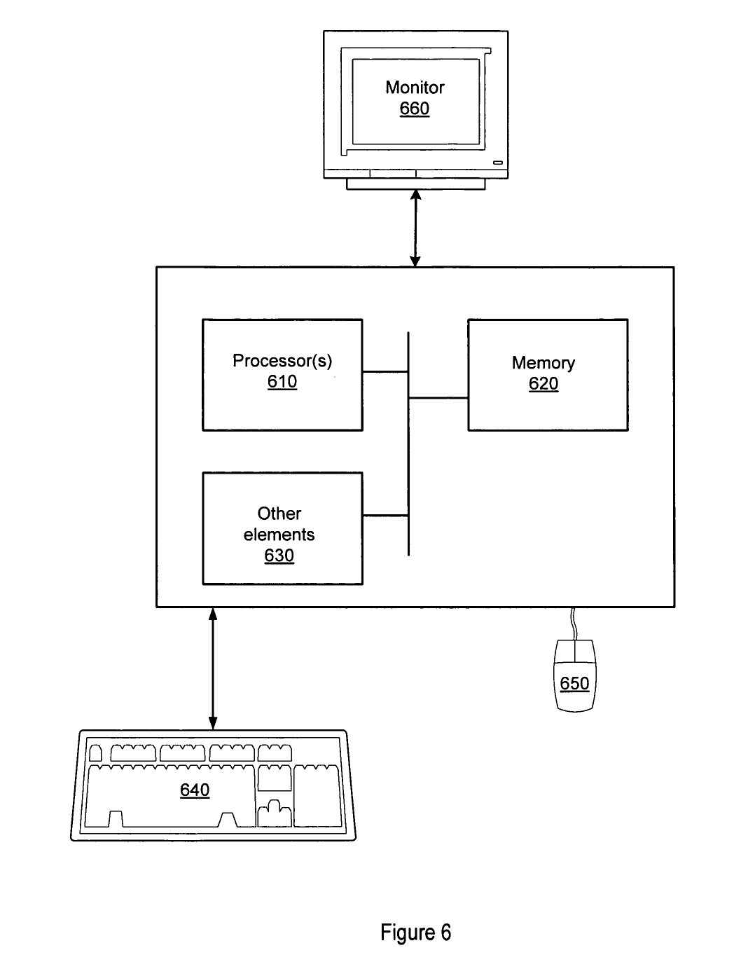

One or more embodiments of the invention may be implemented on virtually any type of computer system regardless of the platform being used. For example, FIG. 6 shows a computer system in accordance with one embodiment of the invention, including a single or multiple processor(s) (610), associated memory (620), and numerous other elements (630). A keyboard (640) and a mouse (650) are connected to the computer system as input devices. A display device (660) is connected to the computer system for display purposes. In one embodiment of the invention, the rasterized SVG images are displayed on this display device (660).

While the invention has been described with respect to a limited number of embodiments, those skilled in the art, having the benefit of this disclosure, will appreciate that other embodiments can be devised that do not depart from the scope of the invention as disclosed herein. Accordingly, the scope of the invention should be limited only by the attached claims.

What is claimed is:

1. A system comprising:
a Scalable Vector Graphics (SVG) image for representing at least one portion of a consumer electronic device; and
a scaler for scaling the SVG image to obtain a scaled SVG image, wherein a display size of the scaled SVG image equals a predefined physical size of the at least one portion of the consumer electronic device, wherein the SVG image is defined by an SVG tag.

2. The system of claim 1 further comprising:
a tag processor for processing the SVG tag to obtain the SVG image.

3. The system of claim 2 further comprising:
a raster image representing the at least one portion of the consumer electronic device; and
an encapsulator for encapsulating the raster image in the SVG tag.

4. The system of claim 1 further comprising:
a rasterizer for rendering the scaled SVG image to obtain a raster image; and
a displayer for displaying the raster image.

5. The system of claim 1 further comprising:
an accumulator for accumulating at least two scaled SVG images to obtain the scaled SVG image, wherein each of the at least two scaled SVG images represents the at least one portion of the consumer electronic device.

6. The system of claim 1 further comprising:
an accumulator for accumulating at least two SVG images to obtain the SVG image, wherein each of the at least two SVG images has the display size equal to the predefined physical size of the at least one portion of the consumer electronic device.

7. The system of claim 1 further comprising:
a display size controller for controlling the display size of the scaled SVG image.

8. A method comprising:
representing at least one portion of a consumer electronic device using a Scalable Vector Graphics (SVG) image, wherein the SVG image is defined by an SVG tag; and
scaling the SVG image to obtain a scaled SVG image, wherein a display size of the scaled SVG image equals a predefined physical size of the at least one portion of the consumer electronic device.

9. The method of claim 8 further comprising:
processing the SVG tag to obtain the SVG image.

10. The method of claim 9 further comprising:
representing the at least one portion of the consumer electronic device using a raster image; and
encapsulating the raster image in the SVG tag.

11. The method of claim 8 further comprising:
rendering the scaled SVG image to obtain a raster image; and
displaying the raster image.

12. The method of claim 8 further comprising:
accumulating at least two SVG images to obtain the SVG image, wherein each of the at least two SVG images represents the at least one portion of the consumer electronic device.

13. The method of claim 8 further comprising:
specifying the display size of the scaled SVG image.

14. A computer readable medium comprising software instructions for enabling a computer system under the control of a processor to:
represent at least one portion of a consumer electronic device using a Scalable Vector Graphics (SVG) image, wherein the SVG image is defined by an SVG tag; and
scale the SVG image to obtain a scaled SVG image, wherein a display size of the scaled SVG image equals a predefined physical size of the at least one portion of the consumer electronic device.

15. The computer readable medium of claim 14 further comprising software instructions to:
process the SVG tag to obtain the SVG image.

16. The computer readable medium of claim 15 further comprising software instructions to:
represent the at least one portion of the consumer electronic device using a raster image; and
encapsulate the raster image in the SVG tag.

17. The computer readable medium of claim 14 further comprising software instructions to:
render the scaled SVG image to obtain a raster image; and
display the raster image.

18. The computer readable medium of claim 14 further comprising software instructions to:
accumulate at least two SVG images to obtain the SVG image, wherein each of the at least two SVG images represents the at least one portion of the consumer electronic device.

19. The computer readable medium of claim 14 further comprising software instructions to:
specify the display size of the scaled SVG image.
